(19) United States
(12) Patent Application Publication
(10) Pub. No.: US 2004/0090454 A1
(43) Pub. Date: May 13, 2004

(54) Method and apparatus for replacing the skin of an onscreen audio player

(75) Inventor: Wen-Chang Lo, Ilan (TW)

Correspondence Address: QUINTERO LAW OFFICE, 1617 BROADWAY, 3RD FLOOR, SANTA MONICA, CA, 90404, US

(73) Assignee: Mitac Technology Corp.

(21) Appl. No.: 10/355,943

(22) Filed: Jan. 31, 2003

(30) Foreign Application Priority Data
Nov. 12, 2002 (TW) 91133180

(51) Int. Cl. G09G 5/00

(52) U.S. Cl. 345/727

(57) ABSTRACT

A method and apparatus for replacing the skin of an onscreen audio player through BIOS flash utility. When running the BIOS flash utility, the CPU retrieves an interrupt request from the BIOS, acquiring the skin stored in the storage device and replacing the default skin located in a ROM of the BIOS. Finally, the skin of the onscreen audio player is displayed on the output device.

### BACKGROUND OF THE INVENTION

1. Field of the Invention

The present invention relates to a method of replacing the skin of an audio player, in which an application replaces a skin of an audio player independent of a computer operating system.

2. Description of the Related Art

Audio player plug-in software enables a computer to play music from within an operating system. The plug-in software, however, does not function alone. Another method of playing music pre-loads an audio player as embedded software in a ROM (Read Only Memory) of at least one system BIOS (Basic Input/Output System), allowing start-up of the audio player without booting the operating system of the computer. The user interface for controlling the operation is normally referred to as a skin fixed in the BIOS ROM. The drawback of this scheme is that the skin is embedded in the BIOS ROM as well as the embedded system so that the skin cannot be changed.

The conventional audio player stored in the BIOS ROM carries a static and unappealing appearance. With current capabilities for personalization, a method of replacing the skin of the audio player is called for.

### SUMMARY OF THE INVENTION

Accordingly, an object of the present invention is to provide a method for replacing the skin of an onscreen audio player with a designated image placed in BIOS through an application, comprising the steps of locating an audio player in the BIOS, getting an image corresponding to the audio player, and updating the skin of the audio player,

The inventive architecture includes a CPU (central processing unit), at least one system BIOS, an output device, a storage device, and at least one skin stored in the storage device. When executing BIOS updating software, the CPU retrieves an interrupt request from the BIOS, acquiring the skin stored in the storage device and replacing the default skin located in a ROM of the BIOS. Finally, the skin of the onscreen audio player is displayed on the output device.

User-created or downloaded and archived images can be used as the new skin of the audio player. A related application is utilized to run BIOS to replace the skin in the OS, making it much more convenient for users.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a diagram of the apparatus for replacing the skin of an onscreen audio player of the present invention;

FIG. 2 is a diagram showing the skin of the onscreen audio player of the present invention;

FIG. 3 is another diagram showing another skin of the onscreen audio player of the present invention;

FIG. 4 is diagram showing the image of the onscreen audio player with a header to be stored in the relative location in the BIOS ROM of the present invention.

### DETAILED DESCRIPTION OF THE INVENTION

Accordingly, the present invention discloses a method and apparatus for replacing the skin of an onscreen audio player.

The present invention writes a skin image of an audio player to flash ROM through at least one system BIOS flash utility. The new image replaces the default image displayed in the flash ROM.

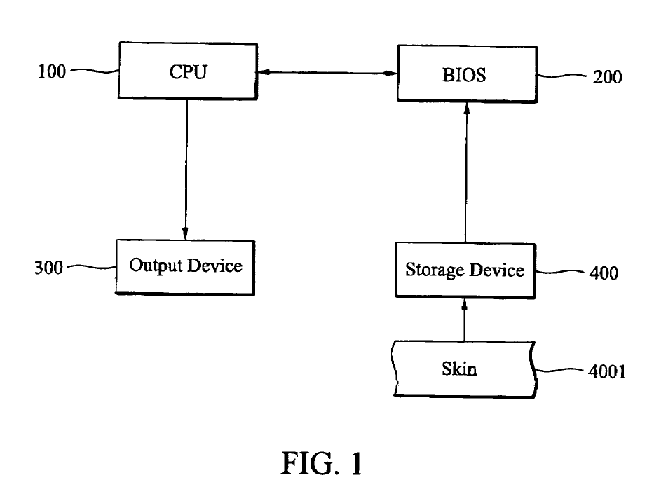

FIG. 1 is a diagram of the apparatus for replacing the skin of an onscreen audio player of the present invention. First, a CPU 100, at least one system BIOS 200, an output device 300, a storage device 400, and at least one skin 4001 are provided,

The present invention sets an audio player in a ROM of the BIOS, with the skin of the audio player located therein as well. The skin of the audio player is implemented by replacement since the space of BIOS ROM is insufficient. It is implemented as mentioned below.

When running BIOS flash utility, the CPU 100 receives an interrupt request from the BIOS 200, and performs the BIOS flash utility. The CPU 100 retrieves the skin 4001 from the storage device 400 through the BIOS 200, thereupon replacing the default skin of the audio player with the skin 4001. Finally, the skin 4001 of the audio player is displayed on the output device 300.

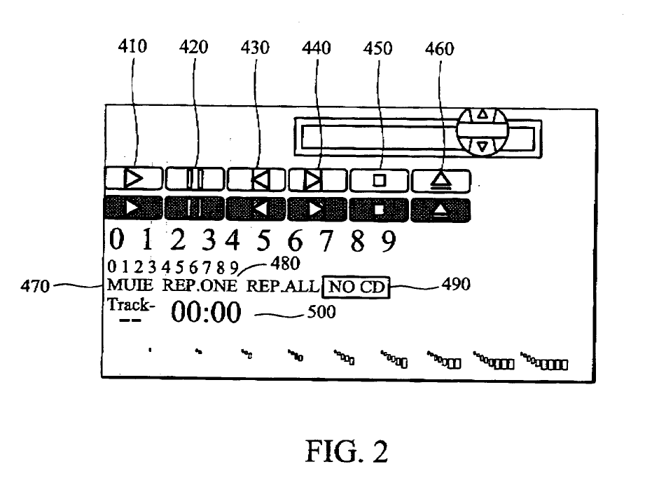

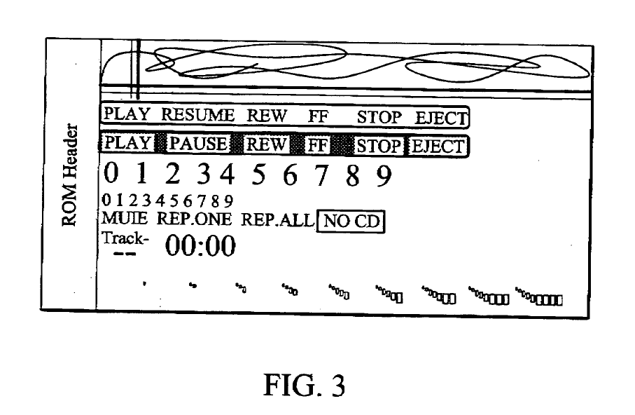

Skin images for the audio player 400 can be designed or downloaded from archived images from a website. A user-created skin image has necessary components for compatibility with fixed format skins of the audio player. Necessary components are buttons or display information corresponding to the audio operations. Necessary components include a play button 410, a pause/resume button 420, a review button (REW) 430, a fast forward (FF) button 440 and a stop button 450; as well as an eject button 460, a mute button 470, a repeat (REP) button 480, a compact disc display region 490 and a time display region 500. Different skin images of the audio player have the necessary components mentioned above, even though their backgrounds may he dissimilar. The necessary components of the skin image are located in fixed positions as shown in FIG. 2 and FIG. 3, producing the skin image according to a specified format by specified image processing software.

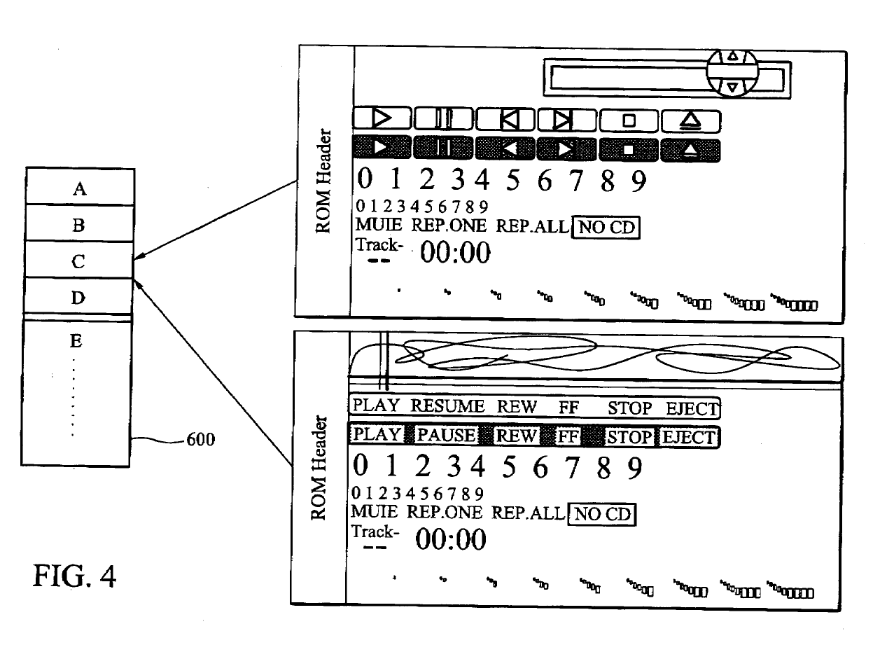

The format of the produced skin image is BMP (bitmap), compressing the produced skin image to suitable size for storage in the BIOS ROM. A ROM header is added while compressing the skin image for determining the region (A, B, C, D and E are dedicated function regions of the BIOS ROM) placed in the BIOS ROM 600. The onscreen audio player can display various skins by modifying the data of specified region (shown in FIG. 4) when replacing the skin image of the audio player.

The present invention enables users to customize skins of the onscreen audio player by replacing the skin image stored in the BIOS ROM through BIOS flash utility executed in the OS.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for replacing a akin of an onscreen audio player, the method comprising the steps of:
setting an audio player in at least one system BIOS ROM of a computer system;
retrieving an image conforming to a format of the audio player from a storage device;
replacing the akin of the audio player using the retrieved image from the storage device.

2. The method as claimed in claim 1, wherein the format of the image of the audio player is BMP.

3. The method as claimed in claim 1, wherein the skin image of the audio player is stored in the BIOS ROM.

4. The method for replacing a skin of an onscreen audio player as claimed in claim 1, wherein the method further comprises a step of composing the new skin, comprising the steps of:
locating a plurality of positions of necessary components of the skin on the default skin;
producing a akin image according to a specified format of the default skin;
compressing the skin image;
adding a ROM header in the skin image; and
judging a location of an image ROM of the BIOS ROM corresponding to the ROM header.

5. The method as claimed in claim 4, wherein the necessary components comprise;
an eject button, a play button, a stop button, a pause/resume button, a review button, and a fast forward button.

6. The method as claimed in claim 5, wherein the necessary components further comprise:
a mute button, a repeat button, a compact disc display region, and a time display region.

7. The method as claimed in claim 4, wherein the BIOS ROM is a flash ROM.

8. An apparatus for replacing the skin of an onscreen audio player, comprising:
a storage device for storage a skin of an audio player;
an output device for showing the skin of the audio player;
at least one system BIOS ROM, coupled with the storage device, for storing the skin of the audio player from the storage device to display the skin of the audio player on the output device; and
a CPU, coupled with the output device and the BIOS ROM, for retrieving the skin from the BIOS ROM to replace the skin of the audio player,

9. The device as claimed in claim Y, wherein the BIOS ROM is a flash ROM.

10. The device as claimed in claim 9, wherein the skin of the audio player is stored in the flash ROM.

11. The device as claimed in claim 10, wherein the BIOS flash utility is run in an operating system to replace the skin of the audio player.
